(19) United States
(12) Patent Application Publication
(10) Pub. No.: US 2003/0048375 A1
(43) Pub. Date: Mar. 13, 2003

(54) Method and apparatus for digitizing light measurements by computer control of light source emission

(76) Inventor: Thorstein Seim, Slependen (NO)

Correspondence Address: KNOBBE MARTENS OLSON & BEAR LLP, 2040 MAIN STREET, FOURTEENTH FLOOR, IRVINE, CA, 92614, US

(21) Appl. No.: 09/952,382

(22) Filed: Sep. 11, 2001

(51) Int. Cl. H04N 5/222

(52) U.S. Cl. 348/370

(57) ABSTRACT

A system for digitizing light measurements controls the emission of a light source illuminating an illumination region to obtain a constant or near constant signal from a light sensitive device. A light source controllably illuminates an illumination region having a test object using a plurality of light signals. A light sensitive device records the plurality of light signals generally modified by the test object in the illumination region and transmits an output signal corresponding to the modified plurality of light signals. A data processor system receives the output signal and generates a control signal. A light source controller is coupled to the data processor system via the control signal. The light source controller controls the operation of the light source, whereby the emitted light signals are adjustably controllable such that the output signal is constant.

### BACKGROUND OF THE INVENTION

1. Field of the Invention

This invention relates to the field of measurement technology. More specifically, the invention relates to a method and apparatus for digitizing light measurements by computer control of light source emission.

2. Description of the Related Technology

In light-measuring instruments with a built-in light source the light level is normally kept at a constant level and is turned on and off according to the process performed by the instrument. A light sensitive device in the instrument is usually adjusted until it is able to properly detect the amount of light from a test and/or reference object. Other imaging systems, not fitted with a light source, are adjusted to the ambient light level. An example is the photographic (film) camera. In order to expose the film correctly the shutter speed and the lens aperture are adjusted, usually after measuring the light from the test object with a light meter.

Digital cameras are also constructed to be able to measure and use the ambient light. For these cameras the light meter is usually the light sensitive image-chip itself. Digital cameras normally contain an electronic shutter, which is used to adjust the amount of light recorded.

### SUMMARY OF CERTAIN INVENTIVE ASPECTS

Inexpensive digital cameras, like those used as web-cameras, are normally not used in precision light measurement instruments. They tend to have limited output resolution range. In addition, the signal output tends to be a non-linear function of the received light intensity. However, the measuring range and the measurement accuracy of such cameras can be improved by controlling the light output from the light source. In order to change the light emission quickly an electronic, not a mechanic control system, should be used.

The invention solves the aforementioned problem by using a Light Sensitive Device (LSD), such as, for example, a camera system containing a CMOS- or a CCD-image chip, to perform precise measurements by digitally controlling the light source output (CMOS: Complementary Metal-Oxide Semiconductor; CCD: Charge Coupled Device). A constant output value is obtained from the LSD such that any non-linearity and range limitation of the LSD output is circumvented. The measurement methods and system are applied to chemical tests and analytes, which are used for diagnostic purposes. The method can be used to measure reflectance, transmittance, fluorescence and turbidity.

Some advantages of the method and system include, but are not necessarily limited to, the following aspects:

The method may be used to expand the LSD measurement range. Even a 1-bit digital output from an LSD can yield a 16-bit resolution for a measurement if the light control Digital-to-Analog Converter (DAC) has a 16-bit resolution.

By calibrating the light output for the DAC controlled light source, a linear response can be obtained from a non-linear LSD as the method is indifferent to the non-linearity usually found in the light response function of a CCD or CMOS camera.

A single transfer function between DAC light control values and analyte concentration can be established.

These and other objects and features of the invention are provided by a method for digitizing light through digital control of the light source. Further, a system using the method and a search-method to obtain the measurement result quickly are presented.

The present invention includes a method for digitizing light recorded from an illuminated test object by digitally controlling the output from a light source. The light from the test object is recorded by a Light Sensitive Device (LSD) and the illumination of the object is varied until a requested Target output from the LSD is obtained. If the test object is changed, the amount of light from it will normally also change. The illumination is then changed until the LSD output again is equal, or nearly equal to the Target value. The setting of the light controller is used to compute the amount of light from each test object. Thus the effect of a limited range and a non-linearity of an LSD can be circumvented.

The method of digitizing light levels by successive approximation to measure a light value, includes:

identifying an output target value of a light sensitive device receiving light signals modified by a test object;

defining an initial step value of an analog to digital converter (ADC) connected to the light sensitive device;

setting the initial step value to be the value of the output of a digital to analog converter (DAC) controlling a light source that provides the light signals, wherein the DAC has an N bit resolution;

repeating one or more adjustments of the DAC output value based on a relationship of the ADC value to the output target value for up to N-1 iterations until the ADC value is equal to the output target value when the adjustments are completed; and

identifying the final DAC output value as a measure of the value of the light signals.

The present invention furthermore discloses a method of digitizing light measurements by controlling the emission of a light source illuminating an illumination region containing a test object, to obtain a constant or near constant signal from the light sensitive device, the method including:

controllably illuminating an illumination region by a plurality of light signals;

modifying the plurality of light signals;

recording the plurality of modified light signals;

transmitting an output signal corresponding to the plurality of modified light signals; and

controlling the operation of a light source based on the output signal, whereby the illuminating light signals are adjustably controllable such that the output signal is constant.

The present invention also includes a system for digitizing light measurements by controlling the emission of a light source illuminating an illumination region to obtain a constant or near constant signal from said light sensitive device. The system includes:

a light source configured to controllably illuminate an illumination region, having a test object, by a plurality of light signals;

a light sensitive device configured to record the plurality of light signals generally modified by the test object in the illumination region and to transmit an output signal corresponding to the modified plurality of light signals;

a data processor system configured to receive the output signal and to generate a controlling signal; and

a light source controller, receivably connected to the data processor system via the controlling signal, the light source controller controlling the operation of the light source, whereby the emitted light signals are adjustably controllable such that said output signal is constant.

In an alternative embodiment, the system includes:

a data processor system configured to generate a controlling signal;

a light source controller responsive to the controlling signal;

a light source responsive to the light source controller;

an illumination region, including a test object, illuminated by the light source; and

a light sensitive device, configured to image the light modified by the test object and to communicate an output signal representative of the modified light to the data processor system, whereby the modified light signal is adjustably controllable such that the output signal is constant.

The output from a Digital-to-Analog Converter (DAC) is used by a microprocessor system to control the output of a light source. Any controllable light source may be used, like Light Emitting Diodes (LEDs). Light (e.g. visible, infra-red, ultra-violet, etc.) from the light source illuminates a test object. Light from the test object is received by an LSD, for example, a digital camera. The Analog-to-Digital output Converter (ADC) of the camera is connected to the microprocessor system. The computer system can then adjust the light intensity until a given Target value output from the LSD is obtained. The procedure can be performed by using a single picture element (pixel) in the camera image of the test object or a group of pixels. Reflected, transmitted, re-transmitted (as for fluorescence) and/or diffused light from the test object can be measured by this method.

DAC adjustments to obtain the Target value are done by a successive approximation search-method. The number of DAC adjustment steps in this method will then define the resolution (number of bits) in the answer. The number of bits is also equal to the number of DAC setting and subsequent reading of ADC values. However, the search can be sped up: By initially calibrating the system set-up (with a Reference test object), a faster search can be performed by doing a fast search in the calibration table, combined with necessary numbers of image capture.

### BRIEF DESCRIPTION OF THE DRAWINGS

FIG. 1 illustrates the system set-up according to an embodiment of the invention, using the method in accordance with the invention. The system uses a microprocessor system to control the output of a light source. The light source illuminates a test object. Light from the test object is received by a Light Sensitive Device. The output from the device is received by the processor system.

FIG. 2 illustrates an example of how the analog output of a Light Sensitive Device can be digitized.

FIG. 3 illustrates an example of a transfer function from DAC output to ADC output from a digital LSD. A white and a non-white object are measured in a set-up similar to that described in FIG. 2. DAC resolution is 16 bit, while ADC (camera) resolution is 10 bit.

FIG. 4 illustrates a fast search example. The ADC minimum (or offset) value is about 200. The ADC maximum (or saturation) value is 1023. The first ADC value M, situated between the maximum value and the minimum value of the ADC, is obtained for the DAC value N_{C}. This value is used to find T_{C}, as described more fully below.

FIG. 5 depicts the non-linear relationship between DAC setting and ADC output. In the measurement presented here the response curve of the non-white object is nearly linear for ADC values above 350 and up to about 750. Above 750, and up to the saturation at 1023, the slope deviates from a straight line (dotted line) and is tilted to the right, as shown. This deviation from non-linearity is typical for many cameras and is similar to the curve presented in the data-cheet for the IBIS camera used by us. Also, any non-linearity between the DAC setting and the light source output will influence the shape of the response curve. See FIG. 6.

FIG. 6a shows measurements of the luminous intensity of a red Light Emitting Diode (LED), as a function of the current through the LED. The response can be approximated by a straight line, as shown.

FIG. 6b shows measurements of the luminous intensity of a blue Light Emitting Diode (LED), as a function of the current through this light source. The response is less linear than for the red LED, but can still be approximated by a straight line for currents above 2 mA.

FIG. 7 shows (schematically) the setup for measuring a circular membrane containing CRP. Before applying the CRP the white membrane is measured. After processing the central part of the membrane becomes colored, as shown in FIG. 8b.

FIG. 8a is an image of the white membrane, recorded by the IBIS camera used in the example.

FIG. 8b is an image of the colored membrane, recorded by the IBIS camera used in the example. The coloring is somewhat uneven.

FIG. 9a shows the spread of pixel values from a white, non-colored surface in FIG. 8a. Target value (650) deviates slightly from the average output value of the pixels. The illumination DAC-value is set at 4082 here.

FIG. 9b shows the spread of pixels from the colored surface in FIG. 8b containing CRP. The spread of pixels is larger than for a white surface. The illumination DAC-value is set at 14505 here.

FIGS. 10-12 are flowcharts illustrating the successive approximation method (SAM) applied for digitization of light levels, FIG. 10 illustrating a single pixel SAM, FIG. 11 illustrating a meta-pixel SAM, and FIG. 12 illustrating a fast meta-pixel SAM.

### DETAILED DESCRIPTION OF CERTAIN INVENTIVE EMBODIMENTS

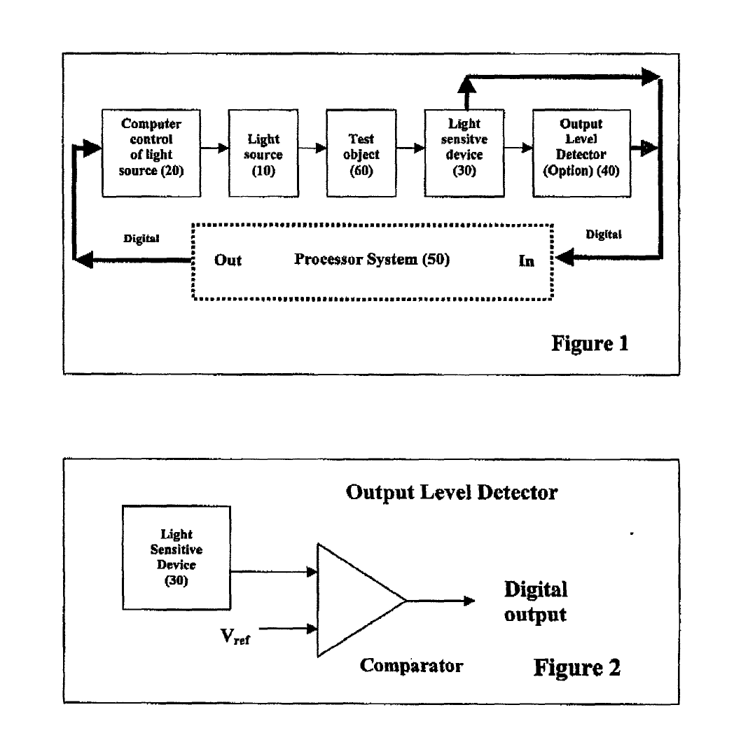

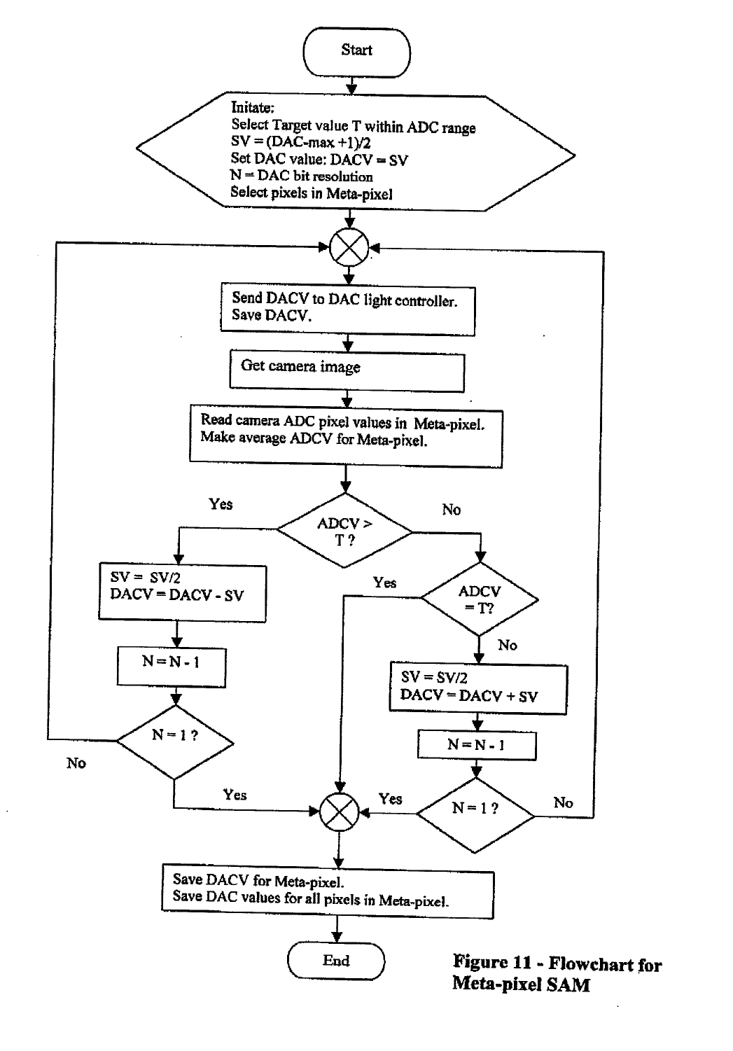

Referring now to FIGS. 1-12, the system according to an embodiment of the present invention comprises:

a light source 10 (e.g. LEDs of different colors);

a light source controller 20 (e.g. a digital-to-analog converter, or DAC);

a light sensitive device (LSD) 30 (e.g. digital or analog camera);

an output level detector 40 (e.g. an ADC Comparator);

a data processor system 50; and

an illumination region 60 (where the test object is disposed).

The invented method of light measurement may be used in the system in accordance with the invention shown in FIG. 1. The system comprises a closed chain of the following functional units:

A processor (computer) 50 that controls the output from a light source power supply 20 (see thick arrow in FIG. 1).

The output of the power supply controls the intensity of a light source 10.

The light source illuminates a test object disposed in an illumination region 60.

Modified (e.g. reflected, transmitted, diffused, etc.) light from the test object is received by a Light Sensitive Device (LSD) 30.

The LSD output is digitized if the output is an analog signal, and The digitized LSD output is read by the processor system 50 (see thick arrow in FIG. 1).

By this system, the light source output can be adjusted to obtain a constant Target value from the LSD. The light source output setting will vary for varying test objects and is used as a measure for the light received from the test object by the LSD.

Spectral information of the light from the test object can be obtained by either using light sources with different spectral emission or filtering a broadband light source before the light reaches the (broad-band) LSD. LED colors can include the visual spectrum, as well as the Near Infrared and the Near Ultra Violet spectral range.

The specific units of an embodiment of the system according to the invention will now be described in further detail:

The processor 50 is able to control the power of the light source 20 by a number of methods.

The current of the light source can be controlled, e.g. by a Digital-to-Analog Converter with current output.

The voltage of the light source can be controlled, e.g. by a Digital-to-Analogue Converter with voltage output.

The output power can be pulsed by the processor. The pulse length and pulse rate can be changed, as may the amplitude of the pulses.

The light source 10 may be any one of light emitting diodes;

incandescent lamps;

gas discharge lamps; or lasers, etc.

The light from the light source can be spectrally filtered if necessary.

A test object generally disposed in an illumination region 60 receives light from the light source 10. Modified (e.g. reflected, transmitted, re-transmitted or diffused) light from the test object is received by the Light Sensitive Device (LSD) 30.

The LSD 30 generally comprises a light detector and necessary support circuits and optics. Possible light detectors comprise:

a photodiode or avalanche photodiode

a phototransistor

a CCD camera chip

a CMOS camera chip

a photomultiplier

The processor system 50 is able to read the output from the LSD 30. If the output is an analog signal (voltage or current), this is transformed into a digital signal. This can be done in one of several ways:

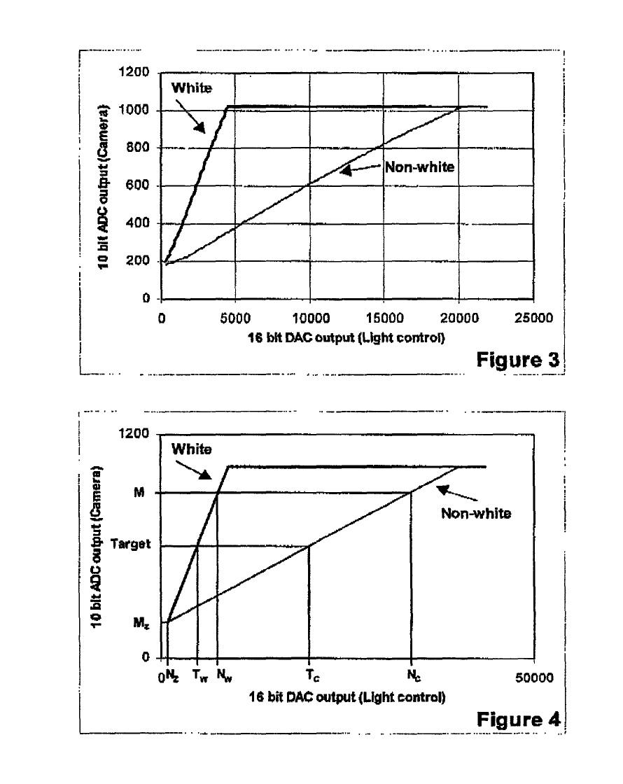

A comparator can be used, as illustrated in FIG. 2.

The voltage or current can be converted into pulses where the pulse rate increases (or decreases) when the voltage or current increases. This can be done by using a voltage (or current)-to-frequency converter. The processor can then measure the time between the pulses (by using its internal clock) and thus digitize the LSD output signal.

An Analog-to-Digital Converter (ADC) can be used.

The processor system 50 receives the output signal from the LSD 30.

If the digitizing method illustrated in FIG. 2 is applied, the following procedure may be used:

V_{ref} is adjusted to a suitable output Target value inside the LSD output range.

The processor 50 adjusts the output of the light source according to the Successive Approximation Method (SAM) described below.

If a camera 30 with digital output is applied, the following procedure may be used:

A digital Target output value T is selected at a suitable value inside the LSD output range.

The processor 50 adjusts the light source output according to the Successive Approximation Method (SAM) described below.

The fastest way of searching for the light level of an unspecified test object is by using the binary Successive Approximation Method (SAM). We will use the SAM when:

the relationship between input and output is unknown, or

the relationship between input and output is linear, or

the relationship between input and output is non-linear but monotonous increasing or decreasing.

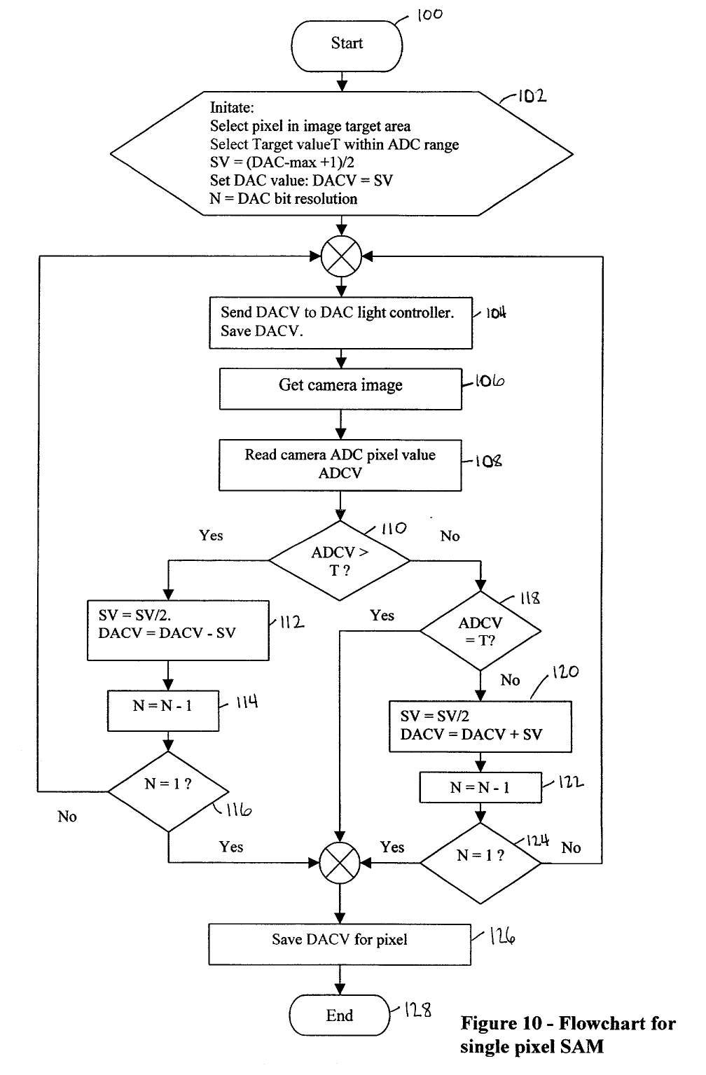

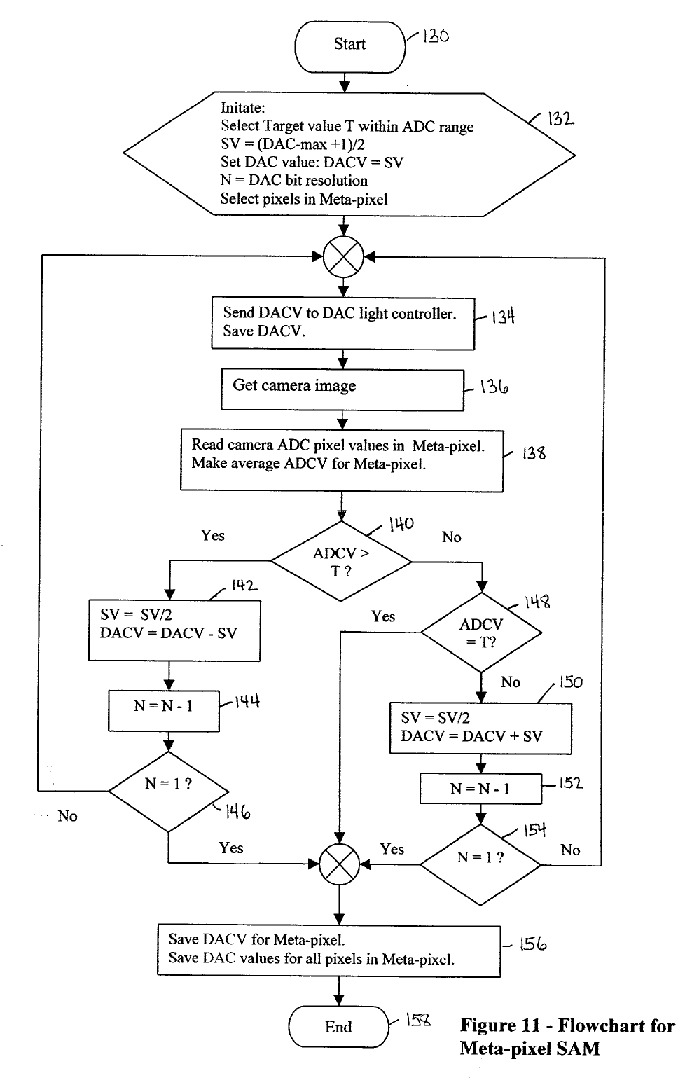

The SAM procedure may be described as follows (cf. flowcharts in FIGS. 10 and 11). Referring initially to FIG. 10, the SAM procedure starts in a step 100. In an initialization step 102, the procedure performs the following subprocedures:

An output Target value T of the LSD is defined. If a digital camera system is used T can be any output value of the output range for the system, but preferably a value in the middle of its range. A single pixel output, or the average of a set of pixel outputs can be used as Target value. See details below. If a LSD with analogue output, connected as shown in FIG. 2, is used the Vref is adjusted to a suitable value (preferably in the middle of the LSD response range).

An initial Step Value (SV) of the DAC is defined as the maximum value +1 of the DAC divided by two. If the DAC has 10-bit resolution its maximum value will be 1023 and the initial SV will be 512.

The initial output of the DAC is set equal to SV.

The steps below will be repeated N-1 times. N is the number of binary digits of the DAC. For example, if the DAC has 10 bit resolution N will be equal to 10.

The following loop is executed:

In steps 104, 106 and 108, the current DAC output value is transferred to the DAC an the resulting output from the ADC is measured.

In a step 110, if the ADC value is higher than T the procedure proceeds to a step 112. In the step 112, the SV is divided by 2, and the new SV value is subtracted from the current DAC output value.

The loop continues N-1 times, as indicated in steps 114 and 116. If N=1, the procedure proceeds to a step 126.

In the step 110 and in a step 118, if the ADC value is lower than T, the procedure proceeds to a step 120.

In the step 120, the SV is divided by 2, and the new SV value is added to the current DAC output value.

The loop continues N-1 times, as indicated in steps 122 and 124. If N=1, the procedure proceeds to the step 126.

In the step 118, if the ADC value is equal to T, not used if the ADC has one bit output range, the procedure proceeds to the step 126, and the loop is terminated.

After the loop is terminated, the current (final) setting of the DAC is recorded and is used as a measure of the light-value, as indicated in the step 126.

Each time the steps 104-124 are repeated the accuracy is improved by one binary digit (bit). To obtain an accuracy of 1/1024 in the saved illuminance value a maximum of ten illuminance adjustments and image recordings have to be made. Most digital camera circuits can record around 10 images per second or more, thus enabling us to obtain an accurate light measurement in about one second or less.

FIG. 11 illustrates a meta-pixel SAM procedure. The procedure starts in a step 130 and ends in a step 158. Steps 132-156 essentially correspond to the steps 102-126 shown in FIG. 10, except for steps 132, 138 and 156.

In the step 132, in addition to selecting an output Target value T, defining an initial Step Value (SV) of the DAC, setting the initial output of the DAC to SV and setting N as the DAC bit resolution, the initialization step 132 includes selecting pixels in meta pixels.

In the step 138, the procedure reads camera ADC pixel values in the meta-pixel. Further, the procedure averages the ADCV for the meta-pixel.

In the step 156, the procedure saves the DACV for the meta-pixel and saves the DAC values for all pixels in the meta-pixel.

Target output value based on more than one pixel

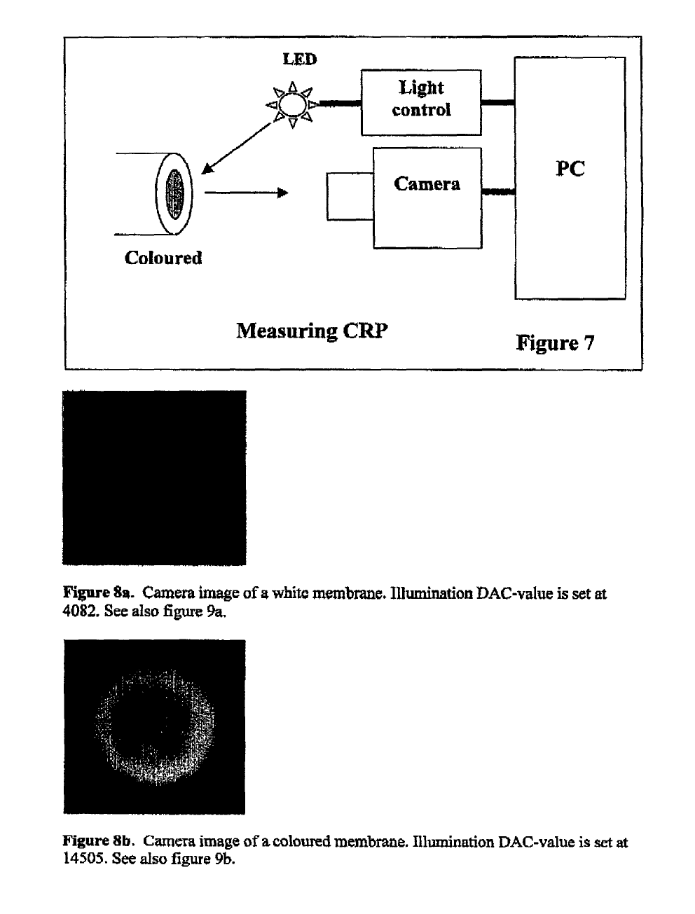

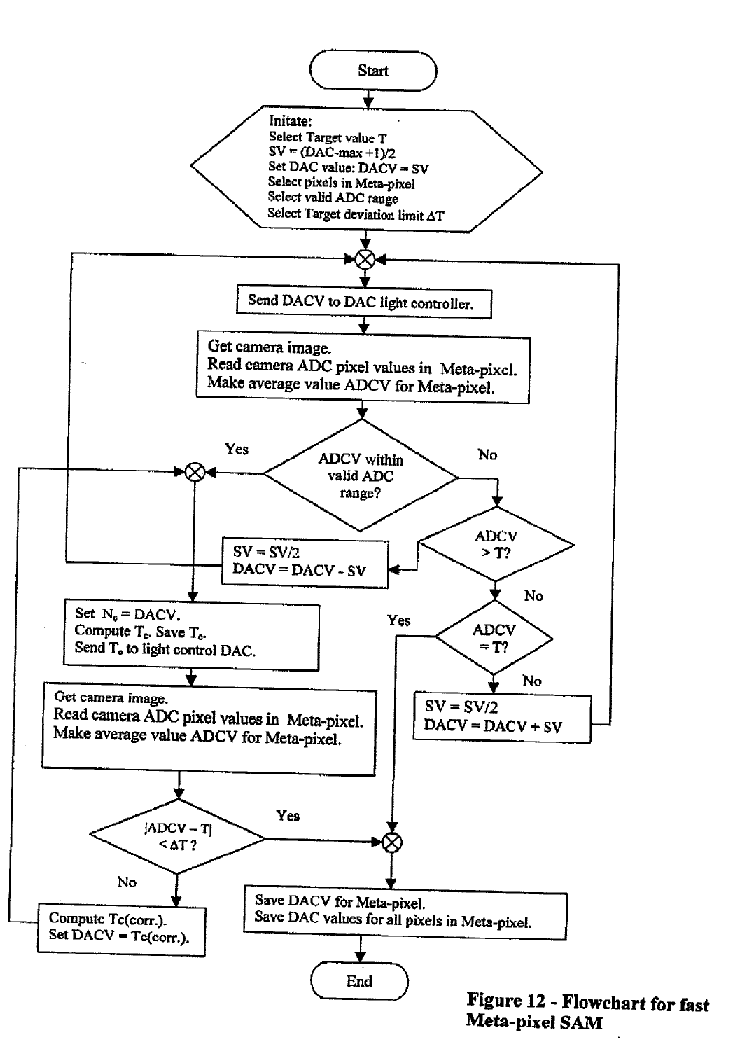

More than one pixel can be used to define a target output value from the camera. By letting the summed or averaged output value from a group of pixels represent a “meta-pixel” the same Target search procedure can be applied upon this “meta-pixel” as on a single pixel. If the test object is a relatively homogenous surface, like a smooth white or colored area, the pixel values of the ADC camera output from this area will only vary within a limited range. See FIG. 9a. If the pixel value range is narrow, i.e., within a near-linear part of the response function (see FIG. 5), the images recorded from the search-procedure described above can be used to adjust each pixel value to compute the DAC-value that yields the Target value. This can be done by linear approximation. If the pixel value range is larger, as in FIG. 9b, they should be divided in sub-groups, each lying within a near-linear part of the response finction. The average of the main sub-group should be used to define the Target value in the searchprocedure described above. For increased accuracy extra images with target values for each group can be recorded.

Even if the surface of the test object is absolute homogenous the pixel outputs from the test object image will vary, due to unavoidable irregulatories in camera pixel sizes, homogenity of illumination, camera optics, etc.

Since the “meta-pixel” is an average of many pixels its numeric resolution is better than that of the ADC output for a single pixel. Or opposite: If the ADC output is 10 bits or higher we can only save the 8 most significant bits and will still obtain high accuracy for the “meta-pixel” value.

Calibration

The relationship between the ADC outputs of the camera and the DAC settings of light intensity can be obtained as follows: A Reference Test Object is used, preferably a white surface if reflectuance is measured, or a clear object if transmittance or light scattering is measured. For each ADC value the corresponding DAC value is recorded in a calibration-table. If the transfer function is a smooth curve only a limited number of measurements have to be made to establish the calibration table.

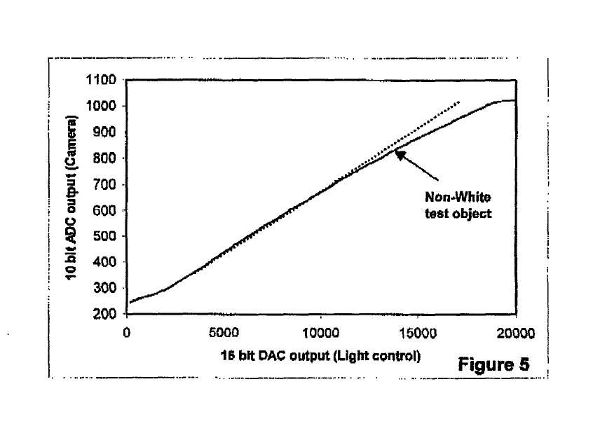

Depending on the setting of camera control parameters the relationship may be similar to the function for light from a white object presented in FIG. 3.

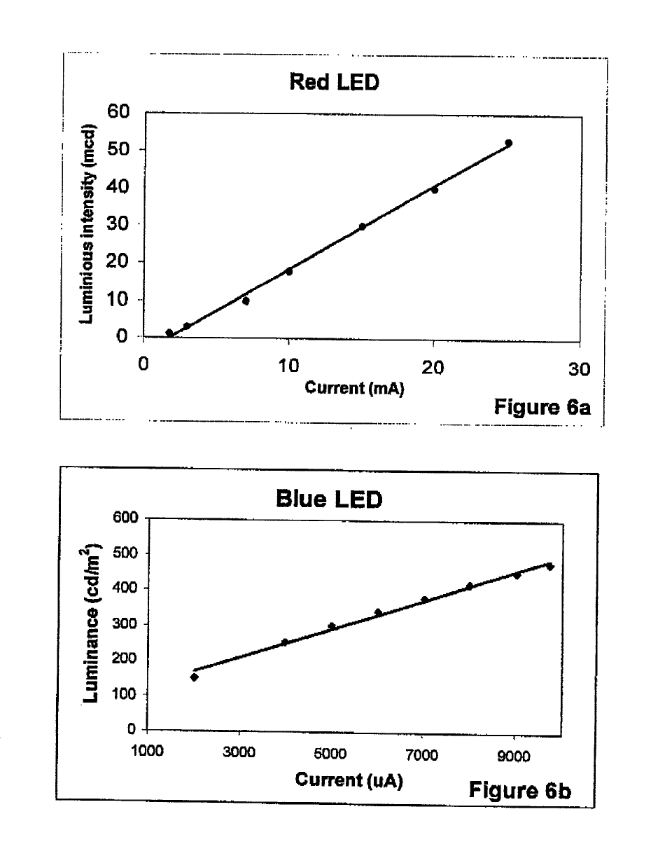

If the relationship between DAC-value and light intensity is close to linear (or linear) this calibration curve can be later used to compute the reflectance for all test object (inside the measurement-range). See FIG. 4 and method described below.

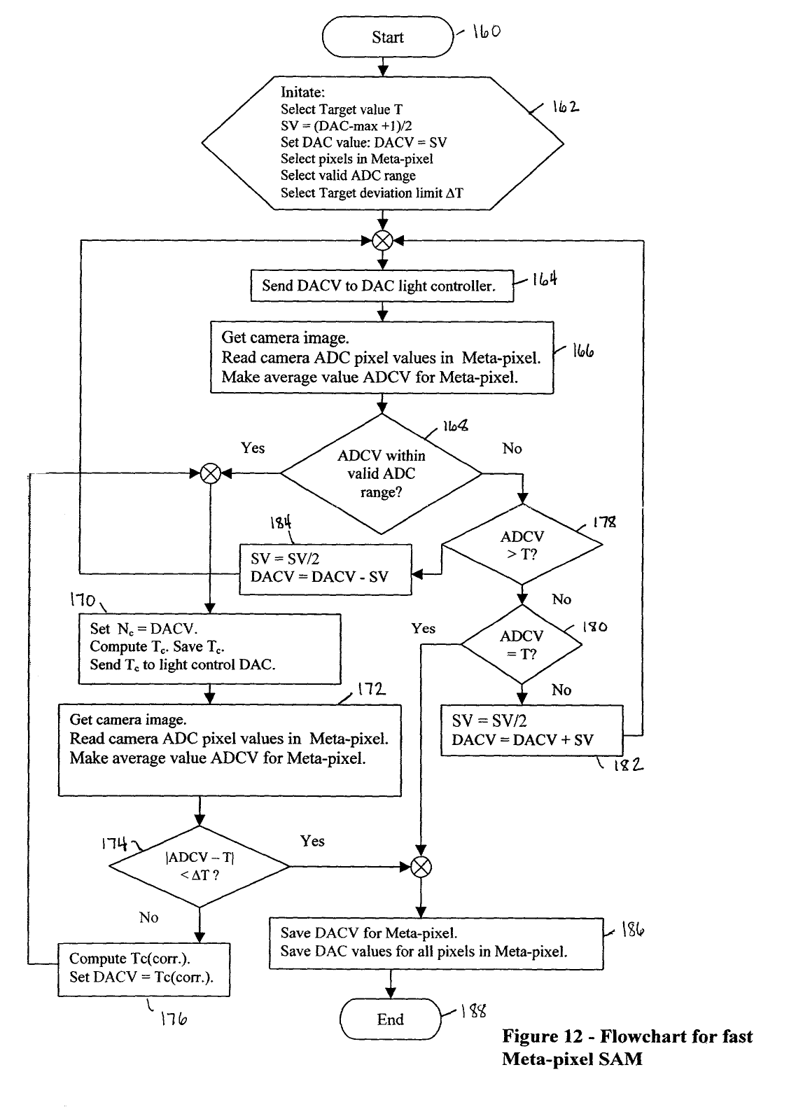

Speeding up the successive approximation method (cf. FIG. 12) This method cannot be used for a single-bit ADC type. like the one shown in FIG. 2)

When the relationship between the DAC input and the ADC output is calibrated for an illuminated Reference object (usually a white object) then the calibration table can be used to obtain a result quickly by the processor system. Reading from tables in the processor memory is normally much faster than adjusting the light source output and subsequently recording the output from the LSD.

Procedure example:

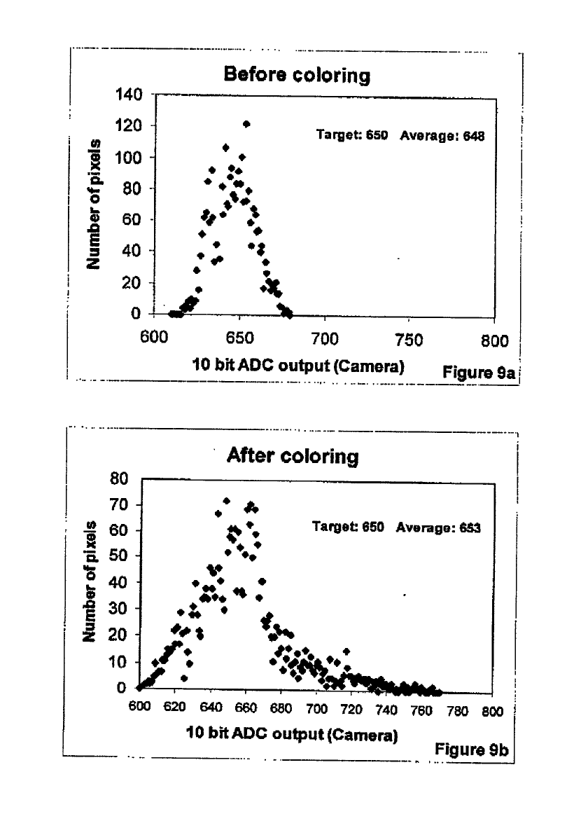

We assume that the relationship between DAC and ADC values has been calibrated as described above and tabulated. In addition, we assume a near-linear relationship between the DAC values and the light intensity. In FIG. 6, we show that this can be assumed for a red and a blue light emitting diode. Finally, we assume a relationship between the DAC and the ADC similar to the function presented in FIG. 3. In FIG. 4, the near-linear response curves in FIG. 3 have been replaced by straight lines (best fit). The response lines for both the white and the non-white object starts at the point (Nz, Mz) and reaches saturation at the ADC maximum value (1023). The equations for straight lines are M=a_{w} N+b_{w} and M=aN+b for the white and the non-white object, respectively. In these equations a_{w}, b_{w}, a and b are known constants. The camera offset value M_{z} is obtained by turning the light off and making a recording of this dark image. In FIG. 4, M_{z} is equal to 185. The M_{z} value is assumed constant for all DAC settings below or equal to N_{z}. The N_{z} value is obtained by entering the point (N_{z}, M_{z)}) into the linear response equation for the white object: N_{z}=(M_{z}−b_{w})a_{w}.

The procedure starts by using the successive approximation method described above, until a DAC value N_{c} results in an ADC value M, that lies between the minimum value N_{z} and the saturation value 1023, as indicated in steps 160-168, 178-184.

As indicated in the step 170, the recorded ADC value is used to convert the tabulated scale, calibrated for a white object, to that of the non-white object. The ADC-value M, which gave N_{c}, is used to find N_{w} from the calibration table. The table also gives the ADC value T_{w} for the Target ADC value. The DAC value T_{c}, giving the Target value for the non-white object, can now be found. From the figure we see that:

(T_{c}−N_{z})/(N_{c}−N_{z})−(Target−M_{z})/(M−M_{z})

or

T_{c}=N_{z}+(Target−M_{z})·(N_{c}−N_{z})/)/(M−M_{z})

The T_{c} value is then transferred to the DAC and the resulting ADC value is read, as indicated in steps 170 and 172.

The received ADC value ADCV might deviate from the T (Target) value, for instance, if there is a (slight) non-linearity between the light source control value and the light source output value, if the camera response is non-linear or if the temperature has changed. An example of non-linearity, measured for a non-white test object, is shown in FIG. 5. If the deviation between T and ADCV is greater than an acceptable (small) limit ΔT then the T_{c} value must be adjusted, as indicated in the steps 174 and 176. Such a correction can be done in many ways. One example is given below.

We may assume that the slope of the line, defined by the constant a in the line-equation presented above, is nearly unchanged. This slope is then given by the equation

a=(T−ADCV)/T_{c}[corr.]−T_{c})

were Tc[corr.] is the corrected Tc-value. From this equation we get:

T_{c}[corr.]=(T−ADCV)/a+T_{c}

T_{c}, determined in the step 170, is substituted by T_{c}[corr.], as indicated in the step 176.

Steps 170-172 can be repeated until the deviation between the ADC value and T is satisfactorily small, as indicated in the step 174.

Measuring reflectance and transmittance

A Reference object (white or transparent) is first measured by said equipment and method. When the Reference object is substituted by a Test object the DAC output is again adjusted until the Target output value is obtained. The DAC(Ref)/DAC(Test) ratio can then be used as a measurement value.

Using a single transfer function between light control and substance concentration

Substance concentration can be computed from the change in reflectance when a surface is coated with various amount of this substance. This relationship is nearly always non-linear. However, all the (non-linear or linear) functions between each component in FIG. 1, and that between reflectance and amount of substance, can be integrated into a common transfer function. Since we have to calibrate the system to find the concentration of a substance with high accuracy the calibration can be done by using the DAC current setting as input. This yields a single (non-linear) transfer function between DAC settings and substance concentration.

Example: CRP measured on membrane.

Test principle:

The CRP test is a solid phase, sandwich-fornat, immunometric assay.

On the test tube in the cartridge there is mounted a white membrane coated with immobilized, CRP specific, monoclonal antibodies.

A diluted and lysed blood sample is transported through the membrane, and the C-reactive proteins in the sample are captured by the antibodies.

The conjugate solution then added, contains CRP specific antibodies conjugated with ultra-small gold particles (purple color). CRP trapped on the membrane will bind the antibody-gold conjugate in a sandwich-type reaction.

Unbound conjugate is removed from the membrane by the washing solution in the last step.

In the presence of a pathological level of CRP in the blood sample, the membrane appears purple. The amount of color increases with the CRP concentration of the sample.

Measurement platform:

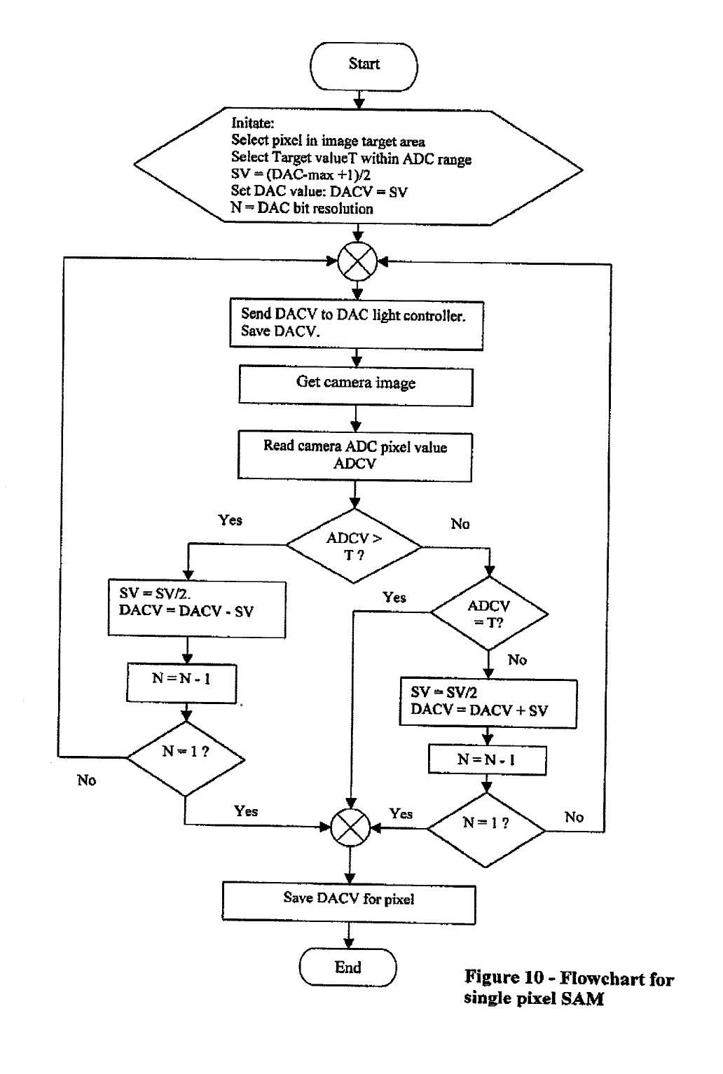

FIG. 7 shows the measurement setup schematically. It uses a PC, an IBIS digital camera from Fillfactory, Mechelen, Belgium and LEDs as light source, controllable by the PC. The test object is a membrane, mounted in front of the camera.

Description of the measurement process:

Insert white membrane.

Generate Light Intensity Image LW. Use algorithm 1.

Run CRP test

Insert colored membrane

Generate Light Intensity Image LC. Use algorithm 1.

Compute Light reflectance image LR=LW/LC

Compute mean color reflectance from image LR.

Compute a quantitative CRP value from the mean color reflectance value and a CRP calibration curve.

Description in detail of Algorithm 1 and definitions:

Generating the Light Intensity Image (LW and LC) Definitions:

T: Target camera value (650)

I: Captured image

IL: List of captured images

L: LED value

LL: List of used LED control values

MaxL: Maximum LED control value (60000)

MinL: Minimum LED control value (300)

C: Camera registered value for one pixel.

CL: List of camera values for one pixels from all captured images

LI: Light intensity for one pixel

MaxC: Max accepted camera value (900)

MinC: Min accepted camera value (400)

NI: Number interpolation iterations (10)

ND: Max number entries used when computing light intensity value (4)

R: Radius used when computing trimmed mean

M: Computed trimmed mean value inside circle of radius R

ML: List of computed trimmed mean values

SL: Percent low entries skipped when computing trimmed mean

SH: Percent high entries skipped when computing trimmed mean

DT: Relative distance to wanted value close to T (10)

Compute trimmed mean value M:

Build a histogram based on pixels inside the colored circle of radius R.

Skip lowest SL and highest SH entries in histogram.

Compute mean.

Algorithm 1:

Set L=MinL, Capture I, Compute M, Store I in IL, Store L in LL, Store M in ML

Set L=MaxL, Capture I, Compute M, Store I in IL, Store L in LL, Store M in ML

Set L=(MinL+MaxL)/2

Set StepL=(MaxL−MinL)/4

Repeat NI times:

Capture I, Compute M, Store I in IL, Store L in LL, Store M in ML

If M>=T then set L=L−StepL

If M<T then set L=L+StepL

Set StepL=StepL/2

End Repeat

Find 3 entries in ML closest to T.

Use corresponding entries in LL to compute best least square line L=A*M+B.

Set Dist=(MaxC−MinC)/DT

Set M0=T-Dist, M1=T, M2=T+Dist

Compute corresponding L0, L1, L2 using least square line L=A*M+B

Set L0=max(L0,MinL), L0=min(L0,MaxL)

Set L1=max(L1,MinL), L1=min(L0,MaxL)

Set L2=max(L2,MinL), L2=min(L0,MaxL)

Set L=L0, Capture I, Compute M, Store I in IL, Store L in LL, Store M in ML

Set L=L1, Capture I, Compute M, Store I in IL, Store L in LL, Store M in ML

Set L=L2, Capture I, Compute M, Store I in IL, Store L in LL, Store M in ML

For each pixel do

Build CL

If max(CL)<=MinC then Set LI=maxL, continue next pixel

If min(CL)>=MaxC then Set LI=minL, continue next pixel

Find ND entries in CL closest to T

Use corresponding entries in LL to compute best least square line L=A*M+B

Set L1=A*T+B

Set LI=max(LI,MinL), L0=min(L1,MaxL)

End for each pixel

End of algorithm 1

The foregoing description and the embodiments of the present invention are to be construed as mere illustrations of the application of the principles of the invention. For example are the invented system and method applicable for any type of light (e.g. infra-red, visible, ultra-violet.)

The foregoing shall thus not limit the scope of the claims, but the true spirit and scope of present invention is defined by the claims.

What is claimed is:

1. A system for digitizing light measurements by controlling the emission of a light source illuminating an illumination region to obtain a constant or near constant signal from a light sensitive device, the system comprising:
a light source configured to controllably illuminate an illumination region, having a test object, by a plurality of light signals;
a light sensitive device configured to record the plurality of light signals generally modified by the test object in the illumination region and to transmit an output signal corresponding to the modified plurality of light signals;
a data processor system configured to receive the output signal and generate a control signal; and
a light source controller, receivably connected to the data processor system via the control signal, the light source controller controlling the operation of the light source, whereby the emitted light signals are adjustably controllable such that said output signal is constant.

2. The system in accordance with claim 1, wherein the light sensitive device is a digital camera.

3. The system in accordance with claim 1, wherein the light sensitive device is a digital video camera.

4. The system in accordance with claim 1, wherein the light sensitive device is an analog camera.

5. The system in accordance with claim 4, additionally comprising an output level detector receivably connected to the light sensitive device and configured to provide a digital signal representative of the output signal of the light sensitive device.

6. The system in accordance with claim 1, wherein said modified light signals are modified by at least one of a reflection from, transmission through, and diffusion by, a said test object in said illumination region.

7. The system in accordance with claim 1, wherein said output signal is an analog signal and wherein said analog output signal is transmitted to an output level detector; said output level detector by means of an adjustable reference voltage Vref yielding a lbit digital output signal.

8. The system in accordance with claim 1, wherein said output signal is a digital signal.

9. The system in accordance with claim 1, wherein the light source current is controlled.

10. The system in accordance with claim 9, wherein said current is controlled by a Digital-to-Analog Converter with current output.

11. The system in accordance with claim 1, wherein the light source voltage is controlled.

12. The system in accordance with claim 11, wherein said voltage is controlled by a Digital-to-Analog Converter with voltage output.

13. The system in accordance with claim 1, wherein the output power is pulsed by said processor.

14. The system in accordance with claim 13, wherein at least one of said pulse length, pulse rate and pulse amplitude is changed.

15. The system in accordance with claim 1, wherein said light source comprises any number of light emitting diodes.

16. The system in accordance with claim 1, wherein said light source comprises any number of incandescent lamps.

17. The system in accordance with claim 1, wherein said light source comprises any number of gas discharge lamps.

18. The system in accordance with claim 1, wherein said light source comprises any number of lasers.

19. The system in accordance with claim 1, wherein said light from said light source is spectrally filtered.

20. The system in accordance with claim 1, wherein said light sensitive device comprises a light detector.

21. The system in accordance with claim 20, wherein said light detector comprises a photodiode or avalanche photodiode.

22. The system in accordance with claim 20, wherein said light detector comprises a phototransistor.

23. The system in accordance with claim 20, wherein said light detector comprises a CCD camera chip or equivalent.

24. The system in accordance with claim 20, wherein said light detector comprises a CMOS camera chip or equivalent.

25. The system in accordance with claim 20, wherein said light detector comprises a photomultiplier.

26. The system in accordance with claim 1, said processor system reading the output from the Light Sensitive Device.

27. The system in accordance with claim 1, wherein the Light Sensitive Device (LSD) output is an analog signal.

28. The system in accordance with claim 27, wherein said analog signal is transformed into a digital signal by means of a comparator.

29. The system in accordance with claim 27, wherein said analog signal is converted into pulses where the pulse rate increases or decreases when the voltage or current increases; said pulse rate increase or decrease being accomplished by using a voltage/current-to-frequency converter; said processor subsequently measuring the time between pulses and thus digitizing the LSD output signal.

30. The system in accordance with claim 27, wherein said analog signal is transformed into a digital signal by means of an Analog-to-Digital Converter (ADC).

31. A system for digitizing light measurements by controlling the emission of a light source illuminating at least one test object in an illumination region, in order to obtain a constant or near-constant signal from a light sensitive device, the system comprising:
a data processor system configured to generate a control signal;
a light source controller responsive to the control signal;
a light source responsive to the light source controller;
an illumination region, including a test object, illuminated by the light source; and
a light sensitive device, configured to image the light modified by the test object and communicate an output signal representative of the modified light to the data processor system, whereby the modified light signal is adjustably controllable such that the output signal is constant.

32. The system in accordance with claim 31, wherein the light source controllably illuminates the test object by a plurality of light signals.

33. The system in accordance with claim 31, wherein the light sensitive device images a plurality of light signals generally modified by the test object.

34. The system in accordance with claim 31, wherein said modified light signals are modified by at least one of a reflection from, transmission through, and diffusion by, a said test object in said illumination region.

35. The system in accordance with claim 31, wherein said output signal is an analog signal and wherein said analog output signal is transmitted to an output level detector; said output level detector by means of an adjustable reference voltage Vref yielding a lbit digital output signal.

36. The system in accordance with claim 31, wherein said output signal is a digital signal.

37. The system in accordance with claim 31, wherein said current is controllable by a Digital-to-Analog Converter with current output.

38. The system in accordance with claim 31, wherein said voltage is controllable by a Digital-to-Analog Converter with voltage output.

39. The system in accordance with claim 31, wherein said light source comprises any number of light emitting diodes.

40. The system in accordance with claim 31, wherein said light source comprises any number of incandescent lamps.

41. The system in accordance with claim 31, wherein said light source comprises any number of gas discharge lamps.

42. The system in accordance with claim 31, wherein said light source comprises any number of lasers.

43. The system in accordance with claim 31, wherein said light from said light source is spectrally filtered.

44. The system in accordance with claim 31, wherein said light sensitive device comprises a light detector.

45. The system in accordance with claim 44, wherein said light detector comprises a photodiode or avalanche photodiode.

46. The system in accordance with claim 44, wherein said light detector comprises a phototransistor.

47. The system in accordance with claim 44, wherein said light detector comprises a CCD camera chip or equivalent.

48. The system in accordance with claim 44, wherein said light detector comprises a CMOS camera chip or equivalent.

49. The system in accordance with claim 44, wherein said light detector comprises a photomultiplier.

50. The system in accordance with claim 31, wherein the Light Sensitive Device (LSD) output is an analog signal.

51. The system in accordance with claim 48, wherein said analog signal is transformed into a digital signal by means of a comparator.

52. The system in accordance with claim 48, wherein said analog signal is converted into pulses where the pulse rate increases or decreases when the voltage or current increases; said pulse rate increase or decrease being accomplished by using a voltage/current-to-frequency converter; said processor subsequently measuring the time between pulses and thus digitizing the LSD output signal.

53. The system in accordance with claim 48, wherein said analog signal is transformed into a digital signal by means of an Analog-to-Digital Converter (ADC).

54. A method of digitizing light levels by successive approximation to measure a light value, the method comprising:
identifying an output target value of a light sensitive device receiving light signals modified by a test object;
defining an initial step value of an analog to digital converter (ADC) connected to the light sensitive device;
setting the initial step value to be the value of the output of a digital to analog converter (DAC) controlling a light source that provides the light signals, wherein the DAC has an N bit resolution;
repeating one or more adjustments of the DAC output value based on a relationship of the ADC value to the output target value for up to N-1 iterations until the ADC value is equal to the output target value when the adjustments are completed; and
identifying the final DAC output value as a measure of the value of the light signals.

55. The method in accordance with claim 54 wherein the adjustments of the DAC output value include:
if the ADC value is greater than the output target value, dividing the step value by two and subtracting the new step value from the current DAC output value, and
if the ADC value is less than the output target value, dividing the step value by two and adding the new step value to the current DAC output value.

56. The method in accordance with claim 54, wherein the output target value is selected to be in the middle of a response range of the light sensitive device.

57. A method of digitizing light measurements by controlling the emission of a light source illuminating an illumination region containing a test object, to obtain a constant or near constant signal from the light sensitive device, the method comprising:
controllably illuminating an illumination region by a plurality of light signals;
modifying the plurality of light signals;
recording the plurality of modified light signals;
transmitting an output signal corresponding to the plurality of modified light signals; and
controlling the operation of a light source based on the output signal, whereby the illuminating light signals are adjustably controllable such that the output signal is constant.

58. The method in accordance with claim 57, wherein the output signal is a digital signal.

59. The method in accordance with claim 57, wherein the output signal is an analog signal and the method additionally comprises converting the analog signal to a digital signal.

60. The method in accordance with claim 57, additionally comprising generating a control signal based on the output signal so as to control the operation of the light source.

61. The method in accordance with claim 57, wherein said processor system receives said output signal from the LSD and a digitizing method comprises:
adjusting Vref to a suitable output Target value inside the LSD output range; and
by means of said processor adjusting the light source output according to a Successive Approximation Method (SAM).
